(19) United States
(12) Patent Application Publication
(10) Pub. No.: US 2009/0223455 A1
(43) Pub. Date: Sep. 10, 2009

(54) TUBULAR ELEMENT

(75) Inventors: Torbjörn Petterson, Gnesta (SE); Jan Kassibrahim, Norsborg (SE)

Correspondence Address: HOVEY WILLIAMS LLP, 10801 Mastin Blvd., Suite 1000, Overland Park, KS, 66210, US

(73) Assignee: DELAVAL HOLDING AB, Tumba (SE)

(21) Appl. No.: 12/092,696

(22) PCT Filed: Oct. 16, 2006
(86) PCT No.: PCT/SE06/50405

§ 371 Date: Sep. 17, 2008

(30) Foreign Application Priority Data
Nov. 4, 2005 (SE) 0502451-8

(51) Int. Cl. A01J 5/04; F16L 11/22; F16L 11/127

(52) U.S. Cl. 119/14.51; 138/115; 138/118; 138/177

(57) ABSTRACT

The invention relates to a tubular element (6). The tubular element includes a body (17) having an outer periphery surface (20) with a shape in a cross section view such that adjacent parts of the periphery outer surface (20) along a circumference of the tubular element (6) forms an outer angle of at least 180° in relation to each other and a first channel (7, 9a, b) located in said body (19) adapted to transport a first fluid medium. The tubular element includes an inner space (18) located entirely inside of the outer periphery surface (20) of the body (19), wherein the inner space (18) is adapted to receive at least one conduit element (17).

### THE BACKGROUND OF THE INVENTION AND PRIOR ART

The present invention relates to a tubular element which comprises a body having an outer periphery surface with a shape in a cross section view such that adjacent parts of the periphery outer surface along a circumference of the tubular element forms an outer angle of at least 180° in relation to each other and a first channel located in said body adapted to transport a first fluid medium.

The outer surface of such a tubular element may have a continuous convex shape around the circumstance of the tubular element. Consequently, the tubular element may have a circular shape or oval shape in a cross section view. Alternatively, the outer surface comprises plane parts connected to each other around the circumference of the tubular element with a greater outer angle than 180° in relation to each other. Such a tubular element may be square shaped. However, the above-defined tubular element has an outer surface with a shape free from cavities. It is very unlikely that an outer surface of a tubular element having such a shape get caught in surrounding objects. Preferably, the tubular element has said shape along at least a main part of its length.

In a milking stall, the long milk tube and the long pulse tubes have an extension in parallel towards a claw of a milking member. In certain cases, one or several electric cables also have an extension in parallel with these tubes. It is known to hold such parallel tubes and electric cables in a connected state by means of special holding members. Inevitably, such a bundle of tubes and cables obtains an irregular outer surface with cavities and gaps between adjacent tubes and cables. During the attachment process and the removing process of the milking member, the bundle of tubes provides a motion in relation to a cow and plural components in the milking stall. If the bundle of tubes gets in contact with, for example, the hooves of the cow or a protruding part of a component during its motion, it is a risk that the bundle gets caught in the cow or the component. Furthermore, it is a risk that dirt is collected in cavities and gaps between adjacent tubes in such a bundle.

DE 196 36 273 shows a flexible milk hose provided with a milk channel, a pulse vacuum channel and an air channel. The flexible milk hose is connected to a milking member at an end portion. In certain cases, an additional conduit element, such as an electrical cable, has to be connected to the milking member in parallel with the milk hose. In these cases, a part of a cow or a component can get caught in the gap between the parallelly arranged milk hose and electrical cable during motions of the milking member.

### SUMMARY OF THE INVENTION

The object of the present invention is to provide a tubular element having a construction, which makes it possible to connect an additional conduit element to the tubular element in a manner such that the risk that the elements in a connected state are caught in an object is just as low as for a single tubular element.

This object is achieved in that the tubular element comprises an inner space, located entirely inside of the periphery outer surface of the body, wherein the inner space is adapted to receive at least one conduit element. Thereby, it is possible to arrange a separate conduit element of a suitable kind in the inner space of the tubular element. Since the inner space is located entirely inside the outer surface of the tubular element, the tubular element will have the same outer shape with or without a separate conduit element arranged in its inner space. Thus, the risk that the tubular element and a separate conduit element in a connected state are caught in an object during a motion is just as low as for the tubular element alone. It is possible to insert a separate conduit element into the inner space of an already fixedly mounted tubular element. It is also possible to insert a separate conduit element to the inner space of the tubular element during the mounting process of the tubular element. It is also a possibility to arrange the conduit element in the inner space of the tubular element as early as during a manufacturing process of the tubular element. In this case, the outer surface of a conduit element may be fixedly connected to the inner surfaces of the inner space of the tubular element. The tubular element may have an inner space having an extension between openings in the end surfaces of the tubular element. If the tubular element only has these openings to the inner space, the conduit element has to be threaded into the inner space from one of the end openings.

According to a preferred embodiment of the invention, the tubular element comprises an opening in the outer periphery surface through which it is possible to insert a conduit element into the inner space. By the use of such a periphery opening, it is easy to insert a conduit element into the inner space of an already mounted tubular element. Advantageously, said opening has an extension along the whole length of the tubular element. In such a case, it is possible to insert a conduit element into the inner space along the whole length of the tubular element or along a desired length of the tubular element.

According to a further preferred embodiment of the invention, the opening comprises a cover member adapted to cover the opening. A tubular element provided with a periphery opening requires a cover member which covers the opening. The cover member may comprise an outer surface which constitutes a part of the outer surface of the tubular element. Thereby, the cover member supplies a required outer surface over the periphery opening in the body. The cover member may be manufactured of a material having elastic properties. An elastic cover member may be displaced between a closed position and an open position in a simple manner. For example, when a conduit element is to be inserted through the periphery opening, the conduit element is pressed with a pressure against the outer surface of the cover member. Thereby, the conduit element moves the elastic cover member from its cover position to an open position. When the cover member is in the open position, it is possible to insert the conduit element into the inner space of the tubular element. As soon as the conduit element has been positioned in the inner space, the elastic cover member is returned to its cover position by means of its elastic properties. The cover member may constitute an integrated part of the body of the tubular element. Thereby, it is possible to manufacture the tubular element in one piece. Alternatively, a suitably shaped separate cover member may be used to cover the periphery opening after that a conduit element has been arranged in the inner space of the tubular element.

According to a further preferred embodiment of the invention, the periphery outer surface of the tubular element has a substantially circular shape in a cross section view. Such a tubular element has an outer surface with a continuously convex shaped outer surface around its circumference. It is very unlikely that a circular shaped outer surface of a tubular element get caught in a surrounding object. Preferably, the tubular element has a circular shape along at least a main part of its length. The parts of the tubular element which risk to get in contact with surrounding objects ought to have an outer periphery surface with a circular shape in cross section.

According to a further preferred embodiment of the invention, the tubular element comprises at least a first part manufactured of a first material having elastic properties. Such a tubular element has a flexibility such that it is possible to bend it in desired directions. Preferably, the tubular element comprises at least a second part manufactured of a second material having different elastic properties than the first material. Thereby, it is possible to give certain parts of the tubular element more flexibility than other parts. The body may comprise a periphery outer part manufactured of the first material and a periphery inner part manufactured of the second material, wherein the first material has softer elastic properties than the second material. Thereby, the walls of the inner channel are made of a stiffer elastic material than the periphery outer part. The use of a stiffer elastic material in the walls of the inner channel reduces the risk that the walls are collapsed during load such that the flow through the channel is stopped up. Thereby, it is possible to make the walls of the inner channel thinner and the tubular element lighter. Alternatively, the parts manufactured of different materials are positioned in the body such that the tubular element obtains different elastic properties in different bending directions. In many cases, it is not necessary that the tubular element has the same soft elastic properties in all bending direction. Thereby, it is possible to provide certain parts of the tubular element with a stiffer elastic material. The parts of stiffer material can be made thinner such that the tubular element achieves a lighter construction.

According to a further preferred embodiment of the invention, the first channel is adapted to transport milk. Consequently, the tubular element is provided with a channel dimensioned to receive and transport milk. If the milk is transported by means of a vacuum source, the walls of the milk channel have to be dimensioned to withstand the vacuum pressure in the milk channel. If a conduit element has an extension in parallel with the tubular element, it is possible to insert such a conduit element through the periphery opening to the inner space of the tubular element in a simple manner. The inner space may be adapted to receive at least one electrical cable. Consequently, the tubular element is provided with an inner space dimensioned to receive at least one electrical cable. If an electrical cable has an extension in parallel with such a tubular element, it is easy to insert the electrical cable into the inner space of the tubular element.

According to a further preferred embodiment of the invention, the tubular element comprises a second channel adapted to transport a second fluid medium. Such a tubular element provides the possibility to transport two different fluid mediums in one tubular element instead of in several separate tubes. Thereby, the number of tubular components will be reduced. The second channel may be adapted to transport air with a pulsation vacuum pressure. The long milk tube and the long pulse tubes in a milking stall have an extension in parallel. These tubes may be replaced by a tubular element having a milk channel and two vacuum pulse channels. The walls of the vacuum pulse channels have to be dimensioned to withstand the vacuum pressure in the pulse channel.

The invention is also directed to a milking stall comprising such a tubular element. The tubular element may here be connected to a milking member.

### BRIEF DESCRIPTION OF THE DRAWINGS

The present invention is now to be explained more closely by means of preferred embodiments, which are disclosed as examples, and with reference to the attached drawings.

FIG. 1 shows a part of a milking stall comprising a tubular element according to the invention,

FIG. 2 shows a cross-section view of a tubular element according to a first embodiment of the invention,

FIG. 3 shows a cross-section view of a tubular element according to a second embodiment of the invention and,

FIG. 4 shows a cross-section view of a tubular element according to a third embodiment of the invention.

### DETAILED DESCRIPTION OF PREFERRED EMBODIMENTS OF THE INVENTION

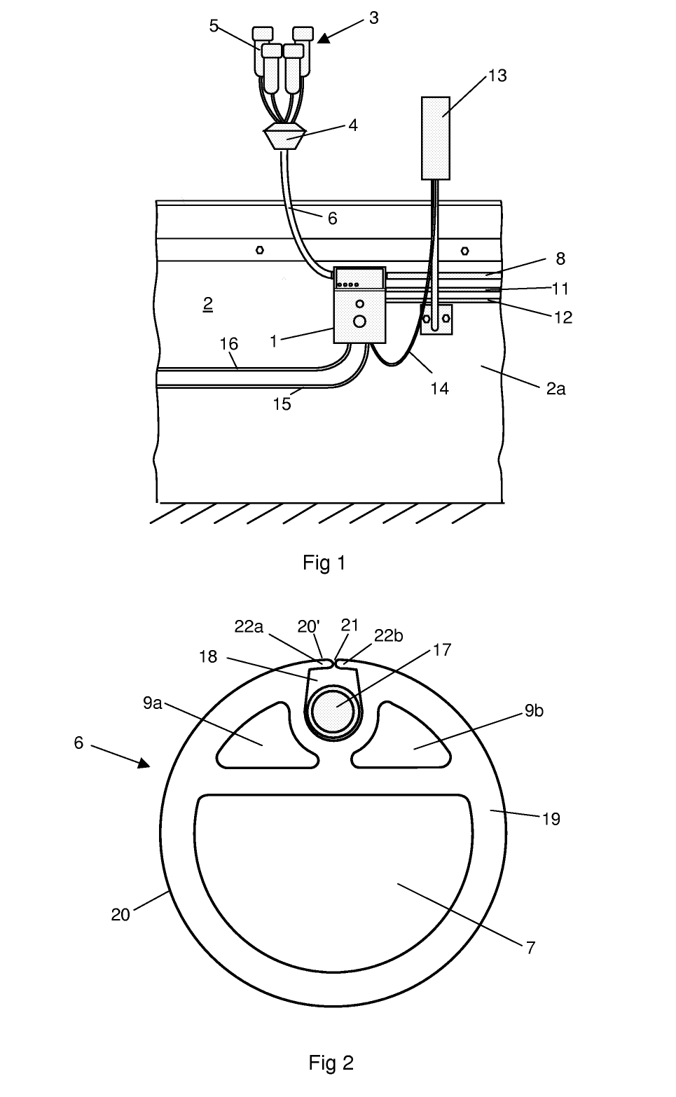

FIG. 1 shows a part of a milking stall for milking of cows. The milking stall comprises a compact modular unit 1 mounted on a wall surface 2a of a pit 2. The milking stall comprises a milking member in the form of a cluster 3, which comprises a claw 4 and four teatcups 5. Each teatcup 5 is connected to the claw 4 by means of a short milk tube and a short pulse tube. However, the four short pulse tubes have not been indicated in the figure. A tubular element 6 is mounted between the claw 4 of the milking member 3 and the compact modular unit 1. The milking stall comprises a milk pipeline system having the function to transport milk from a cow in the milking stall to a milk-collecting container. The milk pipeline system is in a conventional manner connectable to a vacuum source for this transportation of the milk. The milk is transported from the claw 4 to the compact modular unit 1 through a milk channel 7 arranged inside the tubular element 6. The milk channel 7 is shown in FIG. 2. A milk tube 8 conducts the milk from the compact modular unit 1 towards said milk-collecting container. A not visible milk meter is mounted in an inner space of the compact modular unit 1 for measuring of the milk flow through the compact modular unit 1.

Further, the milking stall comprises a vacuum pipeline system, which is arranged to supply a pulsating vacuum to the teatcups 5 during a milking process of an animal. The vacuum pipeline system comprises a not visible pulsator mounted in the inner space of the compact modular unit 1. The vacuum pipeline system comprises two vacuum pulse channels 9a, b in the tubular element 6, which are shown in FIG. 2. The pulse channels 9a, b are arranged to supply a pulsating vacuum from the pulsator, via the claw 4 and the short pulse tubes, to a pulsating chamber of the respective teatcups 5. In order to accomplish pulsating vacuums in the channels 9a, b, the pulsator is connected to a vacuum source via a vacuum tube 11 and a fresh air source via a fresh air tube 12. The pulsator connects the channels 9a, b in the tubular element 6 alternately to the vacuum tube 11 and the fresh air tube 12. Thereby, a pulsating vacuum arises in the respective vacuum pulse channels 9a, b in the tubular element 6, which is supplied to the respective pairs of teatcups 5.

The milking stall comprises a not visible electric control unit mounted in the inner space of the compact modular unit 1. The electric control unit is arranged to control and supervise the milking processes in the milking stall. Consequently, the electric control unit has the function to control several systems used in the milking stall. The electric control unit controls the milking vacuum in the milk pipeline system, the pulsation vacuum and pulsation rate/ratio/stop etc. in the vacuum pipeline system and a schematically indicated remover 13. The remover 13 has the function to remove the cluster 5 from the cow when a milking process is finished in the milking stall. The control unit controls the remover 13 by means of an electric signal line 14. The electric control unit may also have the function to communicate with a main control system for a plurality of milking stalls. Therefore, an electric cable in the form of an electric signal line 15 is connected to the compact modular unit 1. Furthermore, the electric control unit is connected to an electric power source via an electric cable 16. In certain cases, at least one electrical cable 17 has to have an extension from the control unit in the compact modular unit 1 to the claw 4 of the milking member 3. The tubular element 6 is provided with an elongated inner space 18, in which it is possible to releasably mount such an electrical cable 17.

FIG. 2 shows a cross section view of the tubular element 6 in FIG. 1. The tubular element 6 comprises a body 19 manufactured of an elastic material. The body 19 has an outer periphery surface 20 having a substantially circular shape around its circumference. The tubular element 6 has a circular shape along its whole length. The milk channel 7 is dimensioned to transport milk from the claw 4 to the compact modular unit 1. The milk channel 7 has a relatively large cross section area. The two vacuum pulse channels 9a, b are dimensioned to transport pulsating vacuums from the claw 4 to the compact modular unit 1. The vacuum pulse channels 9a, b have smaller cross section areas than the milk channel 7.

The inner space 18 of the tubular element 6 is located entirely inside of the outer periphery surface 20 of the tubular element 6. The inner space 18 is adapted to receive at least one separate conduit element. In this case, an electrical cable 17 has been arranged in the inner space 18 of the tubular element 6. The tubular element 6 comprises an elongated opening 21 in its outer periphery surface 20 to the inner space 18. The opening 21 has a shape and size such that it is possible to insert at least one separate conduit element into the inner space 18. The inner space 18 and the opening 21 have an extension along the whole length of the tubular element 6. The tubular element 6 comprises a cover member, in the form of two cover lips 22a, b adapted to cover the opening 21. The cover lips 22a, b have an extension from opposite sides of the opening 19 to their free edge surfaces which are met in a substantially centre position of the opening 21. The cover lips 22a, b are adapted to substantially completely cover the opening 21 to the inner space 18 when they are in a closed position. The cover lips 22a, b have an outer surface 20′ constituting a part of the outer surface 20 of the body 19. The cover lips 22a, b are manufactured of the same material as the rest of the body 19. The body 19 of the tubular element 6 is manufactured in one piece of one elastic material.

When a separate electrical cable 17 is to be inserted through the periphery opening 21 to the inner space 18, the electrical cable element 17 is pressed with a certain pressure against the outer surface 20′ of the cover lips 22a, b. The pressure from the cable element 17 moves at least a part of the flexible cover lips 22a, b into the inner space 18. Thereby, the cover lips 22a, b are moved from the closed position to an open position. When the cover lips 22a, b are in the open position, it is possible to insert the electrical cable element 17 into the inner space 18. As soon as the electrical cable element 17 has been positioned in the inner space 18, the flexible cover lips 22a, b are returned to the closed position by means of their elastic properties.

During the attachment process of the milking member 3 to a cow and the removing process of the milking member 3 from a cow, the tubular element 6 provides a motion in relation to the cow and several components in the milking stall. Thereby, the tubular element risks getting in contact with parts of the cow and said components. The tubular element 6 has the same circular shaped outer surface 20 along its whole length with or without an electrical cable 17 arranged in the inner space 18. Thereby, the risk that the outer surface 20 of the tubular element 6 gets caught in, for example, the hooves of a cow or a part of a component in the milking stall during the attachment process and the removing process of the milking member 3 is substantially negligible. Furthermore, the use of the tubular element 6 reduces the number of tubular components in the milking stall since it replaces the conventional long milk tube and the two conventional long pulse tubes.

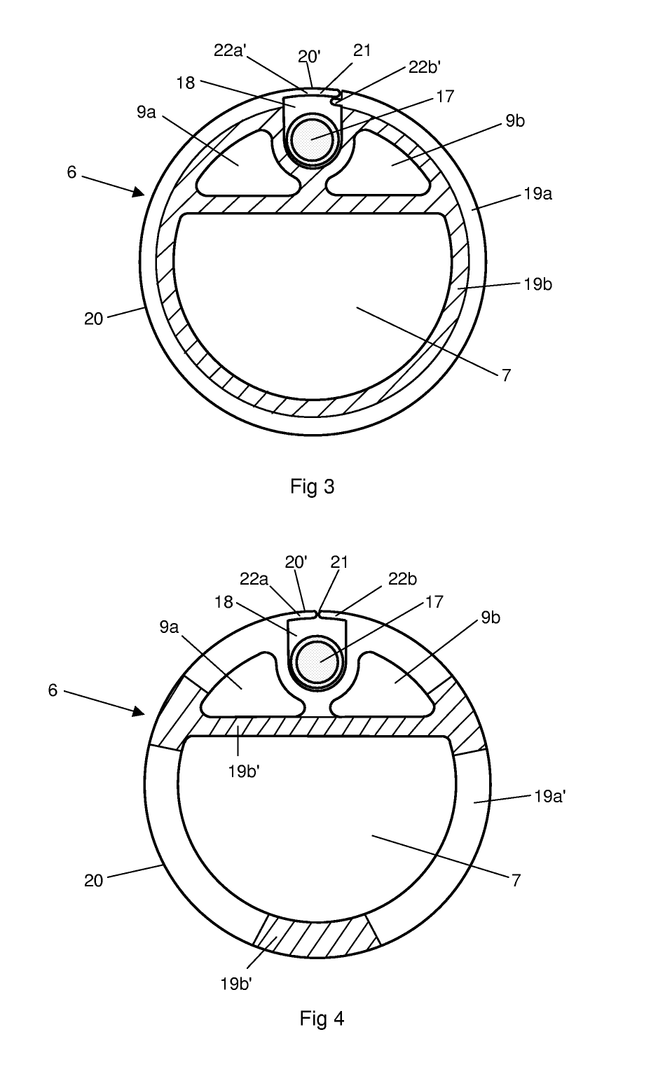

FIG. 3 shows an alternative embodiment of the tubular element 6. In this case, the body 19 comprises a periphery outer part 19a manufactured of a first elastic material. The periphery outer part 19a comprises the periphery outer surface 20 of the body 19. The body 19 comprises a periphery inner part 19b manufactured of a second elastic material. The periphery inner part 19b forms the walls of the milk channel 7 and the pulse channels 9a, b. The first material has softer elastic properties than the second material. Consequently, the milk in the milk channel 7 is transported by means of a vacuum source and the pulse channels 9a, b are arranged to transport a pulsating vacuum. Thereby, the walls of the channels 7, 9a, b have to be dimensioned such that they withstand the vacuum pressure inside the channels 7, 9a, b. By the use of a stiffer elastic material in the periphery inner part 19b of the tubular element 6, the walls of the channels 7, 9a, b can be made thinner. As a result, the tubular element 6 obtains a lower weight. In this case, a first cover lip 22a′ is used having an extension over the whole width of the opening 19. A shorter second cover lip 22b′ is arranged in an internal position of the free end portion of the first cover lip 22a′. In this case, the first cover lip 22a′ provides the whole periphery outer surface 20′ of the cover member.

FIG. 4 shows a further alternative embodiment of the tubular element 6. In this case, the tubular element 6 comprises a body 19 having a soft elastic material in three parts 19a′ and a stiffer elastic material in two parts 19b′. The parts 19a′, 19b′ are positioned in the body 19 such that the tubular element 6 obtains different elastic properties in different bending directions. In certain cases, it is sufficient if the tubular element 6 is bendable in certain directions. One of the stiffer elastic parts 19b′ includes a wall arranged between the milk channel 7 and the pulse channels 9a, b. This stiffer elastic part 19b′ reduces the possibility to bend the tubular element in a horizontal plane in FIG. 4 but not especially in a vertical plane. At the same time, such a stiffer elastic part 19b′ supplies a higher strength to the walls of the channels 7, 9a, b than a softer elastic material. Thereby, it is possible to give at least this part 19b′ a thinner wall thickness than a corresponding wall made of a softer elastic material. In such a manner, the tubular element 6 can obtain a reduced weight.

The invention is not restricted to the described embodiments disclosed in the figures, but may be varied freely within the scope of the claims. It is, for example, possible to provide the tubular element with several separate such inner spaces each adapted to receive at least one conduit element.

1. A tubular element comprising a body having an outer periphery surface, said body having a shape in a cross section view such that adjacent parts of the periphery outer surface along a circumference of the tubular element form an outer angle of at least 180° in relation to each other, a first channel located in said body adapted to transport a first fluid medium, an inner space located entirely inside of the outer periphery surface of the body, wherein the inner space is adapted to receive at least one conduit element, and an opening in the outer periphery surface which is configured and positioned to enable insertion of the conduit element into the inner space, wherein the tubular element further comprises a cover member constituting an integrated part of the body of the tubular element.

2. A tubular element according to claim 1, wherein said opening has an extension along substantially the whole length of the tubular element.

3. A tubular element according to claim 1, characterised in that the cover member comprises an outer surface which constitutes a part of the periphery outer surface of the body.

4. A tubular element according to claim 1, wherein the cover member is manufactured of a material having elastic properties.

5. A tubular element according to claim 1, wherein the periphery outer surface of the tubular element has a substantially circular shape in a cross section view.

6. A tubular element according to claim 5, wherein the tubular element has said shape along a main part of its length.

7. A tubular element according to claim 1, wherein the body comprises at least a first part manufactured of a first material having elastic properties.

8. A tubular element according to claim 7, wherein the body comprises at least a second part manufactured of a second material having different elastic properties than the first material.

9. A tubular element according to claim 8, wherein the body comprises a periphery outer part manufactured of the first a material and a periphery inner part manufactured of a second material, wherein the first material has softer elastic properties than the second material.

10. A tubular element according to claim 8, wherein the parts manufactured of different materials are positioned in the body such that the tubular element obtains different elastic properties in different bending directions.

11. A tubular element according to claim 1, wherein the first channel is adapted to transport milk.

12. A tubular element according to claim 1, wherein the inner space is adapted to receive at least one electrical cable.

13. A tubular element according to claim 1, wherein the tubular element comprises at least one second channel adapted to transport a second fluid medium.

14. A tubular element according to claim 13, wherein the at least one second channel is adapted to transport air with a pulsation vacuum pressure.

15. A tubular element which comprises a body having an outer periphery surface with a shape in a cross section view such that adjacent parts of the periphery outer surface along a circumference of the tubular element forms an outer angle of at least in relation to each other, a first channel located in said body adapted to transport a first fluid medium, an inner space located entirely inside of the outer periphery surface of the body, at least one conduit element arranged in said inner space, and an opening in the outer periphery surface which is configured and positioned to enable insertion of the conduit element into the inner space, wherein the tubular element further comprises a cover member which constitutes an integrated part of the body of the tubular element.

16. A milking stall comprising a tubular element according to claim 1.

17. A milking stall according to claim 16, wherein the milking stall comprises a milking member attachable to an animal to be milked, wherein the tubular element is connected to the milking member.

18. A milking stall according to claim 16, wherein the milking stall comprises a compact modular unit and wherein the tubular element is connected to the compact modular unit.
